(19) United States
(12) Patent Application Publication
(10) Pub. No.: US 2023/0077606 A1
(43) Pub. Date: Mar. 16, 2023

(54) RECYCLABLE TUFTED FABRIC AND METHOD OF MAKING THE SAME

(71) Applicant: Aladdin Manufacturing Corporation, Calhoun, GA (US)

(72) Inventors: Charles Winston REYNOLDS, Calhoun, GA (US); Michael Bejon SETHNA, Cohutta, GA (US); Christopher Lee CRAIG, Calhoun, GA (US)

(21) Appl. No.: 17/759,448

(22) PCT Filed: Jan. 22, 2021
(86) PCT No.: PCT/US2021/014592

§ 371 Date: Jul. 26, 2022

Related U.S. Application Data
(60) Provisional application No. 62/966,196, filed on Jan. 27, 2020.

(51) Int. Cl. D06N 7/00; D05C 17/02; D05C 15/04; D03D 15/46; B32B 5/02; B32B 7/12; B32B 5/26; B32B 3/08

(52) U.S. Cl. CPC D06N 7/0078; D05C 17/026; D05C 15/04; D03D 15/46; B32B 5/022; D05C 17/023; B32B 5/024; B32B 7/12; B32B 5/275; B32B 3/085; D06N 7/0081; D06N 7/0068; D10B 2503/042; B32B 2471/02; B32B 2307/581; B32B 2307/546; B32B 2307/5825; B32B 2307/718; B32B 2262/0276; B32B 2255/02; B32B 2255/26; B32B 2250/20; D06N 2203/061; D06N 2209/103; D06N 2209/1628; B32B 2307/734

(57) ABSTRACT

Recyclable tufted fabrics and methods of preparing the same are provided. In particular, the recyclable tufted fabric includes a fabric backing, a plurality of yarns tufted through the fabric backing such that a pile is provided at a first surface of the fabric backing and a plurality of yarn loops are provided at a second surface of the fabric backing, and a liquid adhesive that anchors the plurality of yarn loops to the second surface of the fabric backing.

### CROSS-REFERENCE TO RELATED APPLICATION

The present application claims the benefit of priority of U.S. Provisional Patent Application No. 62/966,196, filed Jan. 27, 2020, the entire contents of which are hereby incorporated by reference in their entirety for all purposes.

### FIELD

The presently-disclosed invention relates generally to recyclable tufted fabrics and methods of making the same, and more particularly to recyclable tufted fabrics having a unitary construction of like materials and not requiring a secondary backing and methods of making the same.

### BACKGROUND

Conventional tufted fabrics such as carpets and rugs are made up of various components and different types of material. Various components include a fabric backing, secondary backing, latex adhesives and tuft material. It is common practice to produce fabrics such as carpets incorporating a fabric backing of natural or synthetic plastic materials such as polypropylene in a woven fabric form. For example, broadloom carpets are normally produced by having a fabric backing of woven slit film polypropylene into which there is inserted a plurality of tufts by a tufting machine. Tufts may be made from natural or synthetic fibers including wool, polyamides, polyester, polypropylene, and acrylics. These tufts, forming the pile of the carpet, extend through the fabric backing from one face to the other in the form of loops such that long loops on one side form the pile of the carpet and the short loops are located on the opposed side of the backing. Cut pile carpet is achieved by cutting the long loops on the face of the carpet. An adhesive coating, e.g., of latex, is then applied as a fabric anchor coat to the side of the fabric backing opposite the pile side in order to lock the tufts in the fabric backing.

The necessity for an anchor coat such as latex results in a relatively heavy fabric which in some cases lacks optimum flexibility. The latex also has a water component that must be driven off during manufacture, which requires ovens that consume high amounts of energy. In addition, carpets formed with a latex backing require formation on a tenter frame to prevent the latex from shrinking during drying. In addition to the manufacturing inconvenience of using a tenter frame, the residual stress caused by the tenting process requires the rigid and rough carpets made with a latex backing to be stretched when installed, which in turn requires additional labor and components such as tack strips to hold the stretched carpet in place. Even more labor is required to install carpets made with a latex backing in cold climates, as cold temperatures cause the latex to become even more rigid and difficult to install. In some instances, it is required to heat the room before the latex-backed carpet can be installed, which limits installation scheduling and/or wastes energy.

Also, it is well-known in the industry that most carpet is disposed of in a landfill, taking up considerable space thereof. To eliminate the disposal of carpets in landfills requires the construction of carpets of recyclable materials in all parts of the carpet. To date, however, it has been understood in the industry that conventional latex adhesives and hot melt adhesives are not recyclable. See, for example, U.S. Pat. No. 5,240,530. One approach to recyclable carpet would be to dissemble the carpet and recycle the individual materials. Due to the plurality of materials and the conventional adhesives used in this approach to date, this has not been feasible.

Accordingly, there still exists a need for recyclable carpets having a unitary construction without conventional adhesives to eliminate the disadvantages noted above.

### BRIEF SUMMARY

One or more embodiments of the invention may address one or more of the aforementioned problems. Certain embodiments according to the invention provide fully recyclable tufted fabrics having a unitary construction and not requiring a secondary backing. According to a first aspect of the invention, a recyclable tufted fabric comprising a single fabric backing is provided, the tufted fabric comprising a fabric backing, a plurality of yarns tufted through the fabric backing such that a pile is provided at a first surface of the fabric backing and a plurality of yarn loops are provided at a second surface of the fabric backing, and a liquid adhesive that anchors the plurality of yarn loops to the second surface of the fabric backing.

According to some embodiments, the recyclable tufted fabric may not require a secondary backing. According to some embodiments, the plurality of yarns tufted through the fabric backing may not be fused to the fabric backing.

According to some embodiments, the fabric backing is a woven fabric backing. According to some embodiments, the fabric backing and/or the plurality of yarns may comprise polyester. For example, the fabric backing and/or the plurality of yarns can include polyethylene terephthalate (PET), polytrimethylene terephthalate (PTT), or a combination thereof, and the liquid adhesive may include a liquid polyester hot melt adhesive that preferably includes a copolymer of polyethylene terephthalate (coPET). According to some embodiments, the fabric backing may comprise less than 10% of a polyolefin.

According to some embodiments, the plurality of yarns and/or the fabric backing comprise one or more polyamide polymers. According to another embodiment, with the plurality of yarns and/or the fabric backing made from one or more polyamide polymers, the liquid adhesive includes a liquid hot melt adhesive, which can preferably include a copolymer of Polyethylene Terephthalate (CoPET) or a copolymer of one or more polyamide polymers. In other embodiments, a copolymer of one or more polyamide polymers is used as a liquid hot melt adhesive with a fabric backing and/or the plurality of yarns comprising PET, PTT, or a combination thereof.

According to further embodiments, the plurality of yarns and/or the fabric backing comprise polypropylene (PP). According to another embodiment, with the plurality of yarns and/or the fabric backing made from Polypropylene, the liquid adhesive includes a liquid hot melt adhesive, which can preferably include a copolymer of Polyethylene Terephthalate (CoPET), a copolymer of one or more polyamide polymers, or a copolymer of polypropylene (PP). In other embodiments, a copolymer of Polypropylene is used as a liquid hot melt adhesive with a fabric backing and/or a plurality of yarns comprising a polyester, one or more polyamide polymers, or polypropylene.

According to some embodiments, the recyclable tufted fabric comprises a unitary construction using a single or similar synthetic fiber materials. For example, the recyclable tufted fabric may comprise a fabric backing and the plurality of yarns preferably including PET or PTT or a combination of PET and PTT, and a liquid adhesive including CoPET. In another example, the recyclable tufted fabric may comprise a fabric backing and the plurality of yarns including one or more polyamide polymers, and the liquid adhesive including a copolymer of one or more polyamide polymers. In a further example, the recyclable tufted fabric may comprise a fabric backing and the plurality of yarns preferably including polypropylene (PP) and a liquid adhesive including a copolymer of polypropylene (PP).

According to some embodiments, the recyclable tufted fabric may comprise a tuft bind strength of greater than 6.25 lbs loop and greater than 3 lbs cut pile. According to some embodiments, the recyclable tufted fabric may comprise a tear strength of greater than 25 lbs in the cross direction or machine direction. According to some embodiments, the recyclable tufted fabric may comprise a tensile strength of greater than 100 lbs. in the cross direction or machine direction.

According to some embodiments, the recyclable tufted fabric may be free of latex.

According to some embodiments, the liquid adhesive may have a melting temperature from about 130° C. to about 200° C.

According to some embodiments, the recyclable tufted fabric may further comprise a secondary backing adhered to the fabric backing via the liquid adhesive. According to some embodiments, the secondary backing may comprise a woven secondary backing or a nonwoven secondary backing.

According to some embodiments, the secondary backing is a polyester secondary backing. In other embodiments, the fabric backing is a woven polyester fabric backing and the polyester secondary backing is adhered to the woven polyester fabric backing via the liquid polyester holt melt adhesive. In other embodiments, the secondary backing is made of a polyamide polymer or a polyolefin, for e.g., polypropylene (PP).

According to a second aspect of the invention, a method of preparing a recyclable tufted fabric comprising a single fabric backing is provided, the method includes providing a fabric backing, tufting a plurality of yarns through the fabric backing such that a pile is provided at a first surface of the fabric backing and a plurality of yarn loops are provided at a second surface of the fabric backing, and applying a liquid adhesive to the second surface of the fabric backing to anchor the plurality of yarn loops to the second surface of the fabric backing.

According to some embodiments, applying the liquid adhesive to the second surface of the fabric backing may comprise applying the liquid adhesive via a hot melt roller coater, a hot melt slot die coater, a hot melt scatter coater, or a hot melt spray applicator.

According to some embodiments, the recyclable tufted fabric may not require a secondary backing. According to some embodiments, the plurality of yarns tufted through the fabric backing may not be fused to the fabric backing.

According to some embodiments, the method may further comprise adhering a secondary backing to the fabric backing via the liquid adhesive. According to some embodiments, the secondary backing may comprise a woven secondary backing or a nonwoven secondary backing.

According to some embodiments, the recyclable tufted fabric may be free of latex.

According to a third aspect of the invention, a recyclable tufted fabric comprising a single fabric backing is provided, the tufted fabric comprising a fabric backing, a plurality of yarns tufted through the fabric backing such that a pile is provided at a first surface of the fabric backing and a plurality of yarn loops are provided at a second surface of the fabric backing, and a liquid adhesive that anchors the plurality of yarn loops to the second surface of the fabric backing, the liquid adhesive having a melting temperature from about 130° C. to about 200° C.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a tufted fabric backing in accordance with certain embodiments of the invention;

FIG. 2 illustrates application of an adhesive to a tufted fabric backing in accordance with certain embodiments of the invention;

FIG. 3 illustrates a recyclable tufted fabric in accordance with certain embodiments of the invention;

FIG. 4 illustrates a recyclable tufted fabric in accordance with certain embodiments of the invention;

FIGS. 5 and 6 are block diagrams of a method of preparing a recyclable tufted fabric in accordance with certain embodiments of the invention.

### DETAILED DESCRIPTION

The invention now will be described more fully hereinafter with reference to the accompanying drawings, in which some, but not all embodiments of the inventions are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. As used in the specification, and in the appended claims, the singular forms “a”, “an”, “the”, include plural referents unless the context clearly dictates otherwise.

The invention includes, according to certain embodiments, tufted fabrics, such as carpets and rugs, that are fully recyclable. In particular, embodiments of the invention are directed to recyclable tufted fabrics having a single fabric backing. According to an embodiment, the fabric recyclable tufted fabric includes a fabric backing, a plurality of yarns tufted through the fabric backing such that a pile is provided at a first surface of the fabric backing and a plurality of yarn loops are provided at a second surface of the fabric backing, and a liquid adhesive that anchors the plurality of yarn loops to the second surface of the fabric backing. As such, the recyclable tufted fabric preferably has a unitary construction, does not require a secondary backing, and is formed without a latex adhesive. These features make the tufted fabric fully recyclable, dimensionally stable, lightweight, more flexible, easier to transport, cut, and install, particularly in cooler temperatures, and having lower energy costs to produce. Moreover, making a recyclable tufted fabric without a secondary backing allows the end user the option to customize the cushion structure to accommodate specific needs for comfort and performance enhancements. For example, because the recyclable tufted fabric discussed herein is more flexible and softer than conventional carpets, it can be installed with lower-cost carpet pads while providing the feel of carpet installed with higher quality, more expensive carpet pads.

I. Definitions

The term “polymer” may comprise homopolymers, copolymers, such as, for example, block, graft, random, and alternating copolymers, terpolymers, etc., and blends and modifications thereof. Furthermore, unless otherwise specifically limited, the term “polymer” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material. The term “polymer” shall also include polymers made from various catalyst systems including, without limitation, the Ziegler-Natta catalyst system and the metallocene/single-site catalyst system.

The term “tear strength”, as used herein, may refer to a measure of how well a material can withstand the effects of tearing. For example, tear strength may refer to a fabric's resistance to tearing once cut. For the purposes of this disclosure, tear strength may be measured according to ISO 9073-4 and/or NWSP 100.R1.

The term “woven”, as used herein, may comprise a fabric having a structure of individual fibers, filaments, and/or threads that are interlaid in an identifiable repeating manner.

The term “nonwoven”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, hydroentangling, air-laid, and bonded carded needled web processes.

The term “meltspun”, as used herein, may comprise fibers which are formed by extruding molten thermoplastic material as filaments from a plurality of fine, usually circular or trilobal, die capillaries of a spinneret and solidifying the extruded filaments by cooling them as they emerge from the die capillaries.

The term “spunbond”, as used herein, may comprise fibers which are formed by extruding molten thermoplastic material as filaments from a plurality of fine, usually circular or trilobal, capillaries of a spinneret with the diameter of the extruded filaments then being rapidly reduced. According to an embodiment of the invention, spunbond fibers are generally not tacky when they are deposited onto a collecting surface and may be generally continuous.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers are microfibers which may be continuous or discontinuous and are generally tacky when deposited onto a collecting surface.

The term “bicomponent fibers”, as used herein, may comprise fibers formed from at least two different polymers extruded from separate extruders but spun together to form one fiber. Bicomponent fibers are also sometimes referred to as conjugate fibers or multicomponent fibers. The polymers are arranged in a substantially constant position in distinct zones across the cross-section of the bicomponent fibers and extend continuously along the length of the bicomponent fibers. The configuration of such a bicomponent fiber may be, for example, a sheath/core arrangement wherein one polymer is surrounded by another, or may be a side-by-side arrangement, a homo-homo arrangement, a pie arrangement, or an “islands-in-the-sea” arrangement, each as is known in the art of multicomponent, including bicomponent, fibers. The “bicomponent fibers” may be thermoplastic fibers that comprise a core fiber made from one polymer that is encased within a thermoplastic sheath made from a different polymer or have a side-by-side arrangement of different thermoplastic fibers. The first polymer often melts at a different, typically lower, temperature than the second polymer. In the sheath/core arrangement, these bicomponent fibers provide thermal bonding due to melting of the sheath polymer, while retaining the desirable strength characteristics of the core polymer.

II. Recyclable Tufted Fabric

Certain embodiments according to the invention provide tufted fabrics, such as carpets and rugs, that are fully recyclable. For example, certain embodiments of the invention provide recyclable tufted fabrics having a single fabric backing, the fabric backing comprising a fabric backing, a plurality of yarns tufted through the fabric backing such that a pile is provided at a first surface of the fabric backing and a plurality of yarn loops are provided at a second surface of the fabric backing, and a liquid adhesive that anchors the plurality of yarn loops to the second surface of the fabric backing. As such, in some embodiments, the recyclable tufted fabric has a unitary construction of a single material or similar materials, does not require a secondary backing, and is formed without a latex adhesive. These features make the tufted fabric fully recyclable, dimensionally stable, lightweight, easier to transport and install, and having lower energy costs to produce.

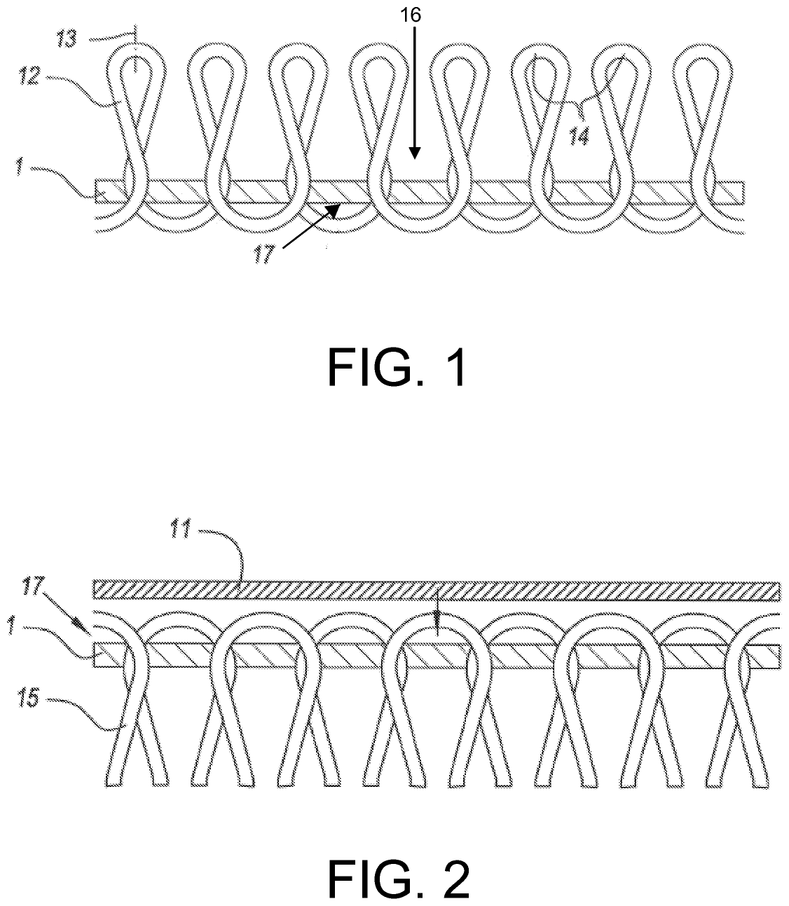

Turning now to FIG. 1, a fabric backing 1 is illustrated in accordance with certain embodiments of the invention. As shown in FIG. 1, the fabric backing 1 has a plurality of yarns 12 tufted therethrough such that a plurality of loops 14 of yarn 12 are provided both at a first surface 10 of the fabric backing 1 and a second surface 17 of the fabric backing 1. As indicated by line 13, the plurality of loops 14 of yarn 12 may be cut to create piles 15, shown in FIGS. 2-4. Although the term “fabric backing” is used throughout, the fabric backing described herein is also referred to in the industry as a “primary backing.”

According to certain embodiments, the fabric backing 1 may be a polyester fabric backing. For example, the fabric backing 1 may include polyethylene terephthalate (PET), polytrimethylene terephthalate (PTT), or a combination thereof. In further embodiments, for instance, the fabric backing 1 may include less than 10% of a polyolefin, e.g., about 5% of a polyolefin. In such embodiments, for example, the polyolefin may have a melting point from about 105° C. to about 180° C. In further embodiments, for instance, the polyolefin may have a melting point of at least 150° C. In certain embodiments, for instance, the polyolefin may include polyethylene (e.g., an ethylene co-polyester). Without intending to be limited by theory, the addition of the polyolefin may improve the tenacity of the fabric backing 1 for processing while only slightly decreasing the recyclability, strength, and dimensional stability of the final tufted fabric. In further embodiments, for example, and as discussed in more detail below, the fabric backing 1 may also comprise a copolyester to improve tenacity.

As further noted above, the fabric backing 1 may be a woven fabric backing. In some embodiments, for example, the woven fabric backing 1 may comprise slit tape; however, the woven fabric backing is not so limited and may instead comprise round, trilobal, or rectangular filaments as understood by one of ordinary skill in the art. In certain embodiments, in the weft direction the woven fabric backing may comprise slit tape at 11-20 picks per inch, 95 millimeter width, and 800-1050 denier. In the warp direction, the woven fabric backing may comprise slit tape at 20-31 ends per inch, 45 millimeter width, and 400-500 denier. An example of a suitable woven fabric backing is the 18 pick Artis® from Propex, 4019 Industry Drive, Chattanooga, Tenn.

Nevertheless, while the fabric backing 1 is principally described as being a woven fabric backing, in some embodiments the fabric backing 1 may be a nonwoven fabric backing. In certain embodiments in which a nonwoven fabric backing is used, for instance, the nonwoven fabric backing may comprise a spunbond, meltblown, or meltspun fabric. In some embodiments, for example, the nonwoven fabric backing may comprise an 80-150 gsm spunbond. In certain embodiments, for example, the nonwoven fabric backing may be bonded and entangled via hydroentangling or needling prior to tufting. In further embodiments, for instance, the nonwoven fabric backing may comprise up to 20% of a low melt copolyester (e.g., coPET) or a low melt copolymer of a polyamide polymer. Indeed, in some embodiments, for instance, the nonwoven fabric backing may comprise a plurality of PET filaments and a plurality of coPET filaments randomly interspersed among the plurality of polyester filaments. This random interspersion can be achieved via, for example, a spunbonding or meltblowing process. In other embodiments, for instance, the coPET filaments may be distributed evenly and/or according to a pattern as understood by one of ordinary skill in the art. In further embodiments, for example, the nonwoven fabric backing may comprise all or a portion of bicomponent fibers having a core formed at least in part by PET and a low melt sheath formed at least in part by coPET. In other embodiments, for instance, the nonwoven fabric backing may comprise bicomponent fibers having a side-by-side arrangement of PET and coPET.

As with the fabric backing 1, the plurality of yarns 12 tufted through the fabric backing 1 may comprise PET, PTT, or a combination thereof.

The plurality of yarns 12 and/or the fabric backing 1, in some embodiments, may also include one or more polyamide polymers. For e.g., the fabric backing and/or the plurality of yarns may include one or more representative polyamide polymers including, but not limited to, polyamide 6, polyamide 11, polyamide 12, polyamide 46, polyamide 410, polyamide 4T, polyamide 56, polyamide 510, polyamide D6, polyamide DT, polyamide DI, polyamide 66, polyamide 610, polyamide 611, polyamide 612, polyamide 6T, polyamide 61, polyamide MXD6, polyamide 9T, polyamide 1010, polyamide 10T, polyamide 1212, polyamide 12T, polyamide PACM12, and polyamide TMDT. In some embodiments, the polyamide comprises a polyamide copolymer, for example but not limited to a polyamide 6/polyamide 66 copolymer, polyamide 6/polyamide 6T copolymer, polyamide 61/polyamide6T copolymer, polyamide 66/polyamide 6T copolymer, or polyamide 12/polyamide MAMCI copolymer. In particular embodiments, the polyamide is polyamide 6.

In further embodiments, the fabric backing 1 and/or the plurality of yarns 12 may include a polyolefin, for e.g., Polypropylene.

As discussed above, the plurality of yarns 12 may include a tufted cut and loop arrangement, for example, having ⅛, 1/10, or 3/16 gauges. Additionally, in some embodiments, for instance, the plurality of yarns may be sized at 300-1500 denier and 2-20 denier per filament.

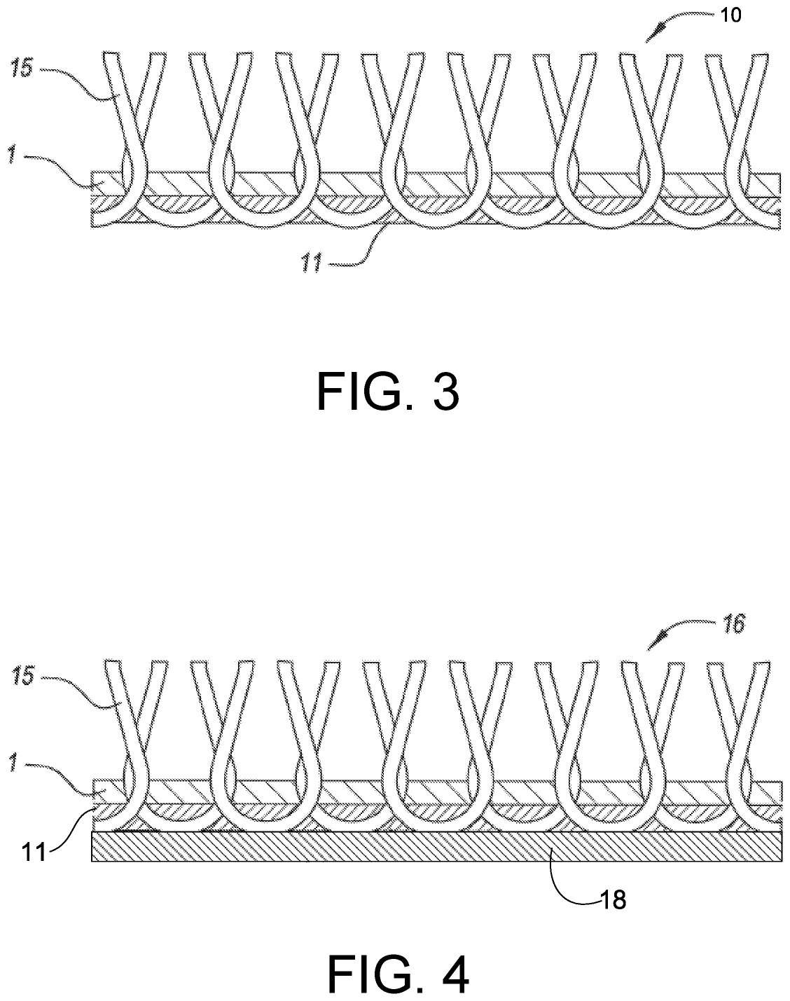

Additionally, referring to FIG. 2 and FIG. 3, to form recyclable tufted fabric 16, an adhesive 11 is applied to the second surface 17 of the fabric backing 1 that anchors the plurality of loops 14 of yarn 12 to the second surface 17 of the fabric backing 1. For example, FIG. 2 illustrates the application of adhesive 11 to tufted fabric backing 1 to form recyclable tufted fabric 16, as illustrated in FIG. 3. In applying adhesive 11, however, the loops 14 of yarn 12 do not need to be further fused to the fabric backing 1 such as with relative movement between a heated roll or knife and the loops of the tufts as is known in the prior art. In some embodiments, for example, adhesive 11 may be a glue. For instance, in further embodiments, adhesive 11 may be a liquid glue comprising, for example, copolymer of polyethylene terephthalate (coPET) or copolymer of polytrimethylene terephthalate (coPTT). Indeed, in some embodiments, the adhesive 11 may be a liquid hot melt adhesive, e.g., molten CoPET.

In some embodiments, the adhesive 11 may include a liquid hot melt adhesive that is preferably a copolymer of one or more polyamide polymers discussed above. In other embodiments, the adhesive 11 may include a liquid hot melt adhesive that is preferably a copolymer of a polyolefin, for e.g., polypropylene (PP).

In certain embodiments, the recyclable tufted fabric 16 is a unitary construction entirely made of like or similar materials. For example, the recyclable tufted fabric 16 can include a polyester fabric backing with a plurality of polyester yarns tufted therethrough and can further include a liquid hot melt adhesive that is a copolymer of polyethylene terephthalate (CoPET). Similarly, the recyclable tufted fabric 16 could include a polyamide fabric backing with a plurality of polyamide yarns tufted therethrough and can further include a liquid adhesive that is a copolymer of one of the polyamide polymers. Likewise, the recyclable tufted fabric 16 could include a polypropylene (PP) fabric backing with a plurality of polypropylene (PP) yarns tufted therethrough and can further include a liquid adhesive that is a copolymer of polypropylene (PP). In such unitary constructions, including an adhesive 11 that is a copolymer of the material forming the plurality of yarns and the fabric backing ensures that the adhesive 11 has a lower melting point than the yarn or the backing. This allows the adhesive to anchor the plurality of loops 14 of yarn 12 to the second surface 17 of the fabric backing 1.

In certain other embodiments, the recyclable tufted fabric 16 is constructed out of a combination of different materials. For example, the recyclable tufted fabric 16 can include a polyester backing with polyamide yarns tufted therethrough and a CoPET adhesive anchoring the polyamide yarns to the polyester backing. In another example, the recyclable tufted fabric 16 can include a polyamide backing with polypropylene (PP) yarns tufted therethrough and a CoPET adhesive anchoring the PP yarns to the polyamide backing. It shall be understood that the construction of the recyclable tufted fabric 16 is not restricted to the above combinations.

In certain embodiments, for example, the liquid adhesive 11 may have a melting temperature from about 130 to about 200° C. In some embodiments, for instance, the liquid adhesive 11 may have a weight of 3-16 oz/yd². In further embodiments, for example, the liquid adhesive 11 may have a weight of 5-8 oz/yd². For example, in some embodiments the recyclable tufted fabric 16 may have a unitary construction and, in such embodiments, the liquid adhesive may have a weight of about 7.5-8 oz/yd². In other embodiments discussed in more detail below, the recyclable tufted fabric 16 may include a secondary backing and, in such embodiments, the liquid adhesive may have a weight of the fabric backing (primary) of about 5-6 oz/yd². Additionally, the liquid adhesive 11 may comprise a dart impact strength of greater than 250 g, an intrinsic viscosity of 0.35-0.45 dl/g, and a melt viscosity at 160° C. of 32-37 Pa·s.

While the fabric backing 1 alone provides good dimensional stability to the recyclable tufted fabric 16, the application of the liquid adhesive 11 to the second surface 17 of the fabric backing 1 not only anchors the plurality of yarn loops 14 to the second surface 17 of the fabric backing 1 but also further improves the dimensional stability of the recyclable tufted fabric 16. Indeed, the recyclable tufted fabric 16 may be sufficiently dimensionally stable that it may be installed with low or no tension, such as, for example, by installing with adhesive tape rather than stretching the fabric 16 over a tack strip. Additionally, the recyclable tufted fabric 16 is resistant to differential growth or shrinkage and movement due to temperature changes. In the event the recyclable tufted fabric 16 were to grow or shrink, the fabric backing 1 and the liquid adhesive 11 have the same coefficient of expansion such that they would move together, thus reducing the potential for doming or curling. As a result, the recyclable tufted fabric 16 does not require a secondary backing.

The recyclable tufted fabric 16 may have a tuft bind strength of greater than 6.25 lbs loop and greater than 3 lbs cut pile., The recyclable tufted fabric 16 may comprise a tear strength of greater than 25 lbs in the cross direction or machine direction. In addition to the tuft bind strength, the application of the liquid adhesive 11 to the second surface 17 of the fabric backing 1 also further improves tensile strength for the recyclable tufted fabric 16 (along with the fabric backing 1). For example, the recyclable tufted fabric 16 may comprise a tensile strength of greater than 100 lbs. in the cross direction or machine direction. Moreover, the recyclable tufted fabric 16 may comprise a dimensional stability of less than 3% total in both the cross and machine directions.

Additionally, in certain embodiments, for example, the recyclable tufted fabric 16 may have a face-weight of 16-80 oz/yd². For instance, in some embodiments, the recyclable tufted fabric 16 may have a face-weight of 40-80 oz/yd². The face of the recyclable tufted fabric 16 may also be about 12-15 feet wide. Moreover, in certain embodiments the recyclable tufted fabric 16 may have a weight of the fabric backing of about 2-6 oz/yd². In further embodiments, the recyclable tufted fabric 16 may have a weight of the fabric backing of about 2-4 oz/yd². Such weights may also improve tear resistance, tensile strength, and tuft bind strength. However, while going beyond these weights may further improve tear resistance, tensile strength, and tuft bind strength, the fabric backing may become uneconomical as too much raw material is required to make a saleable product.

Although the recyclable tufted fabric 16 does not require a secondary backing, in some embodiments, such as that shown in FIG. 4, the recyclable tufted fabric 16 may optionally include a secondary backing 18 in order to, for example, provide additional weight and/or structure to the recyclable tufted fabric 16 and/or reduce the amount of adhesive 11. In such embodiments, the secondary backing 18 may be adhered to second surface 17 of the fabric backing 1 via the liquid adhesive 11. In this case, the adhesive 11 serves to both secure the tufts to the primary fabric backing 1 and also adhere the secondary backing 18 thereto. As with the fabric backing 1 and the plurality of yarns 12 tufted through the fabric backing 1, the secondary backing may comprise polyethylene terephthalate (PET), polytrimethylene terephthalate (PTT), or a combination thereof. In certain embodiments, for example, the secondary backing may be 100% polyester. Also, as with the fabric backing 1 and the plurality of yarns 12, the secondary backing may include a polyamide polymer or a polyolefin, for e.g., polypropylene (PP).

Additionally, in those embodiments including a secondary backing 18, the secondary backing 18 may be a woven secondary backing or a nonwoven secondary backing. In embodiments in which a woven secondary backing is used, for example, the woven secondary backing may comprise 5-12 picks per inch and a weight of 2-8 oz/yd². For example, in some embodiments, the secondary backing 18 may have a weight of 2-5 oz/yd². In further embodiments, the secondary backing 18 may have a weight of 3 oz/yd². In other embodiments in which a nonwoven secondary backing is used, for instance, the nonwoven secondary backing may comprise a spunbond, meltblown, carded/needled, or meltspun fabric. In further embodiments, the nonwoven secondary backing may comprise multiple layers having any combination of spunbond, meltblown, and meltspun fabric bonded together as understood by a person of ordinary skill in the art. For example, the nonwoven secondary backing may comprise a 60-120 gsm spunbond. In further embodiments, for instance, the secondary backing may comprise a carded and/or needled pad having a weight of 5-35 oz/yd². Additionally, in such embodiments that include a secondary backing 18, the recyclable tufted fabric 16 may comprise a delamination strength of greater than 2.5 lb/inch. As above with the fabric backing 1, going beyond the weights discussed herein may further improve tear resistance, tensile strength, and tuft bind strength, but the secondary backing 18 may become uneconomical as too much raw material is required to make a saleable product.

As described above, the tufted fabric 16 in some embodiments has a unitary construction, does not require a secondary backing, and is formed without a latex adhesive. These features make the tufted fabric fully recyclable, dimensionally stable, lightweight, more flexible, easier to transport, cut, and install, particularly in cooler temperatures, and having lower energy costs to produce.

III. Method of Preparing a Recyclable Tufted Fabric

In another aspect, certain embodiments according to the invention provide methods of preparing a recyclable tufted fabric. In accordance with certain embodiments, the method comprises providing a fabric backing, tufting a plurality of yarns through the fabric backing such that a pile is provided at a first surface of the fabric backing and plurality of yarn loops are provided at a second surface of the fabric backing, and applying a liquid adhesive to the second surface of the fabric backing to anchor the plurality of yarn loops to the second surface of the fabric backing. In applying liquid adhesive, however, the yarn loops do not need to be further fused to the fabric backing such as with relative movement between a heated roll or knife and the loops of the tufts as is known in the prior art.

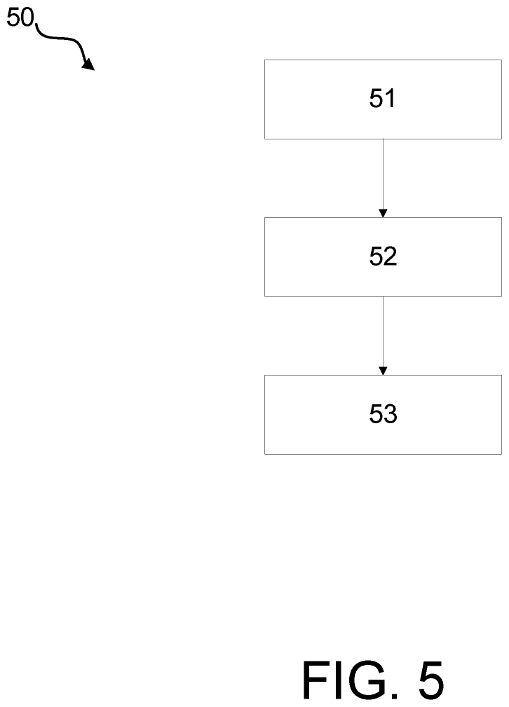

FIG. 5, for example, is a block diagram of a method 50 of preparing a recyclable tufted fabric in accordance with certain embodiments of the invention. As shown in FIG. 5, the method 50 includes the following steps:

Step S51: Providing a fabric backing;

Step 52: Tufting a polymer yarn through the fabric backing such that a pile is provided at a first surface of the fabric backing and a plurality of yarn loops are provided at a second surface of the fabric backing; and

Step 53: Applying a liquid adhesive to the second surface of the fabric backing to anchor the plurality of yarn loops to the second surface of the fabric backing.

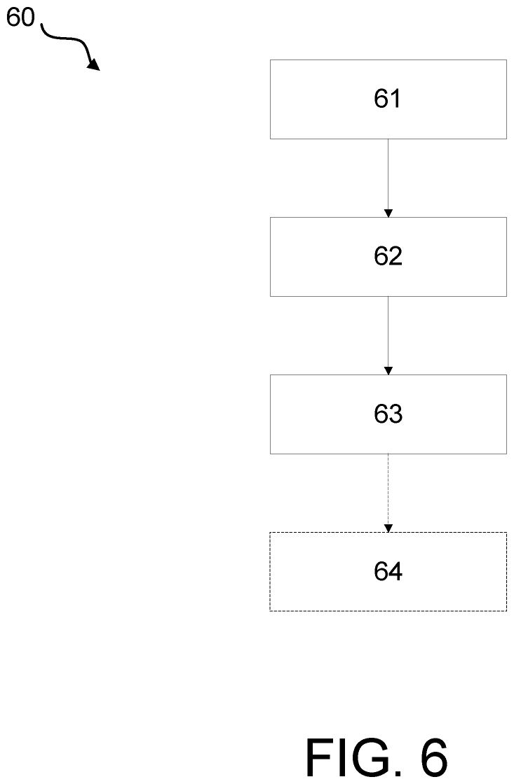

As discussed previously herein, however, the recyclable tufted fabric may optionally include a secondary backing adhered to the woven polyester fabric backing via the liquid adhesive. FIG. 6 is a block diagram of a method 60 of preparing a recyclable tufted fabric in accordance with certain embodiments of the invention, including the optional application of the secondary backing. As shown in FIG. 6, the method 60 includes the following steps:

Step 61: Providing a fabric backing;

Step 62: Tufting a polymer yarn through the fabric backing such that a pile is provided at a first surface of the fabric backing and a plurality of yarn loops are provided at a second surface of the fabric backing;

Step 63: Applying a liquid adhesive to the second surface of the fabric backing to anchor the plurality of yarn loops to the second surface of the fabric backing; and

Step 64: Adhering a secondary backing to the fabric backing via the liquid adhesive.

According to certain embodiments, for instance, applying the liquid adhesive to the second surface of the fabric backing comprises applying the liquid adhesive via a hot melt roller coater, a hot melt slot die coater, a hot melt scatter coater, or a hot melt spray applicator. While some heat may be required to melt the liquid adhesive, less heat and energy is needed than that needed for existing products using conventional latex adhesives, which require the use of dryers to dry off the water present in the latex adhesives.

Moreover, according to certain embodiments of the invention, for example, tufting the plurality of yarns into the fabric backing may comprise tufting with a tufting machine as understood by a person having ordinary skill in the art.

In this regard, the method provides a tufted fabric has a unitary construction, does not require a secondary backing, and is formed without a latex adhesive. These features make the tufted fabric fully recyclable, dimensionally stable, lightweight, more flexible, easier to transport, cut, and install, particularly in cooler temperatures, and having lower energy costs to produce.

### EXAMPLES

### Example 1: General Carpet Characteristics

Various carpet samples were tested for dimensional stability, break strength, tuft bind, wear, shrinkage, and pilling, as shown in Tables 1 and 2 below. Dimensional stability was measured by two methods: (1) the percent change in length and width following cycles of stress and relief, and (2) the Aachen Stability Test according to ASTM D7570. Break strength was measured by determining the number of pounds of force required to break the sample. Tuft bind was measured according to ASTM D1335. Wear was measured using a hexapod drum tester according to ASTM D5252. Shrinkage was measured in both length and width following manufacturing. Pilling was measured according to ASTM D2859.

Table 1 shows testing results for carpet samples using the liquid adhesive described herein at different carpet gauges, face weights, and amounts of glue applied.

Table 2 shows testing results for various carpet samples, with Sample 1 being the recyclable tufted fabric using the liquid adhesive having a melt point of approximately 150° C. and attached to a nonwoven carded/needled polyester pad containing recycled content, Samples 2-3 being two examples of the recyclable tufted fabric using the liquid adhesive described herein having a melt point of approximately 150° C. without a pad, where the liquid adhesive is a liquid polyester hot melt adhesive. Samples 4-9 are constructed in the same manner as Samples 2-3 except using a commercial hot melt adhesive having a lower melt point of approximately 130° C., and Sample 10 being a Control Sample of a conventional carpet using a latex adhesive. All experimental samples (Samples 1-9) had 3/16 gauge tufted primary and included yarn tufts that were half PET and half PTT. Samples 1, 2, and 5-9 had a face weight of 55 oz/yd², and Samples 3 and 4 had a face weight of 40 oz/yd². Samples 1, 2, and 5-9 had a stitch rate of 19.5 stitches/3 in., and Samples 3 and 4 had a stitch rate of 17.5 stitches/3 in.

TABLE 1
Part 1

| Sample | 1 | 2 | 3 | 4 | 5 | 6 | 7 | 8 |
|---|---|---|---|---|---|---|---|---|
| Gauge (in) | 1/10 | 1/10 | 3/16 | 1/10 | 1/10 | 1/10 | 3/16 | 3/16 |
| Face Weight (oz/yd²) | 50 | 50 | 45 | 45 | 45 | 45 | 45 | 45 |
| Glue Weight (oz/yd²) | 10 | 8 | 8 | 8 | 8 | 8 | 10 | 10 |
| Dimensional Stability: MD (%) | 0.46 | 0.77 | 1.04 | 0.77 | 0.76 | 1.16 | 0.84 | 1.58 |
| Dimensional Stability: CD (%) | 0.44 | 0.84 | 0.7 | 0.88 | 0.36 | 0.79 | 0.67 | 1.16 |
| Dimensional Stability: | 0.9 | 1.61 | 1.74 | 1.65 | 1.12 | 1.95 | 1.51 | 2.74 |
| Unrecovered Ext. (%) | | | | | | | | |
| Break Strength: Length (lbs) | 133 | 136 | 113 | 102 | 90 | 97 | 105 | 104 |
| Break Strength: Width (lbs) | 134 | 128 | 124 | 93 | 102 | 103 | 129 | 120 |
| Tuft Bind (lbs) | 5.1 | 4.6 | 5.1 | 4.2 | 4.4 | 3.4 | 5.2 | 4.7 |
| Hexapod per 12,000 cycles | 3.5 | 3.5 | 3 | 3 | 3 | 3 | 3.5 | 3 |
| Dimensional Stability: | N/A | N/A | 0.020 | 0.014− | 0.017 | 0.017 | 0.046− | N/A |
| Aachen Length After 48 Hrs | | | | | | | | |
| Dimensional Stability: | N/A | N/A | 0.048− | 0.020− | 0.014 | 0.057− | 0.071− | N/A |
| Aachen Width After 48 Hrs | | | | | | | | |
| Shrinkage: Length (%) | N/A | N/A | 0.271 | 0.273 | 0.000 | 0.41 | 0.136 | N/A |
| Shrinkage: Width (%) | N/A | N/A | 0.272 | 0.000 | 0.000 | 0.000 | 0.273 | N/A |
| Shrinkage: Avg. (%) | N/A | N/A | 0.27 | 0.13 | 0.000 | 0.2 | 0.2 | N/A |

Part 2

| Sample | 9 | 10 | 11 | 12 | 13 | 14 | 15 | 16 |
|---|---|---|---|---|---|---|---|---|
| Gauge (in) | 3/16 | 1/10 | 1/10 | 3/16 | 3/16 | 1/10 | 1/10 | 3/16 |
| Face Weight (oz/yd²) | 45 | 45 | 50 | 45 | 45 | 45 | 45 | 45 |
| Glue Weight (oz/yd²) | 10 | 10 | 10 | 8 | 10 | 10 | 8 | 15 |
| Dimensional Stability: MD (%) | 1.03 | 1.08 | 0.88 | 1.24 | 0.55 | 0.88 | 0.72 | 0.49 |
| Dimensional Stability: CD (%) | 0.6 | 0.7 | 0.51 | 1.13 | 0.67 | 0.97 | 0.4 | 0.44 |
| Dimensional Stability: | 1.63 | 1.78 | 1.39 | 2.37 | 1.22 | 1.85 | 1.12 | 0.93 |
| Unrecovered Ext. (%) | | | | | | | | |
| Break Strength: Length (lbs) | 111 | 107 | 141 | 99 | 105 | 119 | 117 | 121 |
| Break Strength: Width (lbs) | 131 | 109 | 126 | 122 | 113 | 115 | 119 | 147 |
| Tuft Bind (lbs) | 5.2 | 4.6 | 5.6 | 3.4 | 5 | 5.5 | 5.8 | 4.4 |
| Hexapod per 12,000 cycles | 12000 | 12000 | 12000 | 12000 | 12000 | 12000 | 12000 | 12000 |
| Dimensional Stability: | 3 | 3.5 | 3.5 | 3.5 | 3 | 3.5 | 3.5 | 3.5 |
| Aachen Length After 48 Hrs | | | | | | | | |
| Dimensional Stability: | N/A | 0.076 | 0.021 | N/A | 0.036− | N/A | N/A | 0.020 |
| Aachen Width After 48 Hrs | | | | | | | | |
| Shrinkage: Length (%) | N/A | 0.069− | 0.058 | N/A | 0.021− | N/A | N/A | 0.048− |
| Shrinkage: Width (%) | N/A | 0.000 | 0.192 | N/A | 0.000 | N/A | N/A | 0.271 |
| Shrinkage: Avg. (%) | N/A | 0.271 | 0.197 | N/A | 0.137 | N/A | N/A | 0.272 |

TABLE 2

| Sample | 1 | 2 | 3 | 4 | 5 | 6 | 7 | 8 | 9 | 10 |
|---|---|---|---|---|---|---|---|---|---|---|
| Dimensional Stability: | 6.22 | 1.37 | 0.89 | 1.43 | 1.78 | 1.95 | 2.65 | 2.27 | 2.83 | 2.36 |
| Unrecovered Ext. (%) | | | | | | | | | | |
| Pilling (Pass/Fail/Not Tested) | P | P | P | P | P | NT | NT | NT | NT | NT |
| Break Strength: Length (lbs) | 337 | 107 | 120 | 112 | 109 | 114 | 110 | 104 | 113 | 241 |
| Break Strength: Width (lbs) | 267 | 109 | 135 | 137 | 95 | 118 | 112 | 94 | 104 | 253 |
| Tuft Bind (lbs) | 3.1 | 4.8 | 5.3 | 4.6 | 4 | 3.5 | 5 | 5.5 | 3.8 | 5.2 |
| Hexapod per 12,000 cycles | 3.5 | 3 | 3 | 2.5 | 3.5 | 3.5 | 3.5 | 3.5 | 3.5 | 4 |
| Dimensional Stability: | 0.013− | 0.023 | 0.008 | 0.008 | 0.008− | NT | NT | NT | NT | NT |
| Aachen Length After 48 Hrs | | | | | | | | | | |
| Dimensional Stability: | 0.054− | 0.011− | 0.002− | 0.036 | 0.008− | NT | NT | NT | NT | NT |
| Aachen Width After 48 Hrs | | | | | | | | | | |

As can be seen in Tables 1 and 2, the recyclable tufted carpets described herein perform well under standard carpet testing procedures.

### Example 2: Cut Resistance

Three samples each of three different carpets were subjected to cut resistance testing to determine the number of pounds of force required to cut through the carpets, as shown in Table 3 below. To test cut resistance, each carpet was subjected to a razor cutting blade while held in a tensile tester. The measurement was taken by placing the razor blade at a 30° angle and pulling the carpet through the blade to measure the pounds of force required to cute the carpet. Carpet 1 is the recyclable tufted fabric using the liquid polyester hot melt adhesive described herein having a melt point of approximately 150° C. Carpet 2 is a carpet formed in the same manner as Carpet 1 except using a commercial hot melt adhesive having a melt point of approximately 130° C. Carpet 3 is a conventional carpet using a latex adhesive.

TABLE 3

| | Carpet 1 | Carpet 2 | Carpet 3 |
|---|---|---|---|
| Sample 1 (lbs) | 2.9 | 2.3 | 8.5 |
| Sample 2 (lbs) | 3.1 | 2.2 | 8.0 |
| Sample 3 (lbs) | 2.9 | 2.7 | 6.1 |
| Average (lbs) | 3.0 | 2.4 | 7.5 |

As can be seen in Table 3, the recyclable tufted fabrics described herein provide less cut resistance than conventional carpets using latex adhesives, indicating that these recyclable tufted fabrics are softer and easier to cut and otherwise manipulate than conventional carpets.

### Example 3: Stiffness

Three samples each of three different carpets were subjected to cantilever stiffness testing to determine the distance the carpet must extend out of a roller in inches for a sample to bend and touch the measuring surface upon exiting the roller. The stiffness testing was conducted with both room temperature and frozen samples prepared in a standard household freezer, with Table 4 showing results for room temperature samples and Table 5 showing results for frozen samples. As with Example 2, Carpet 1 is the recyclable tufted fabric using the liquid polyester hot melt adhesive described herein having a melt point of approximately 150° C. Carpet 2 is a carpet formed in the same manner as Carpet 1 except using a commercial hot melt adhesive having a melt point of approximately 130° C. Carpet 3 is a conventional carpet using a latex adhesive.

TABLE 4
Room Temperature

| | Carpet 1 | Carpet 2 | Carpet 3 |
|---|---|---|---|
| Sample 1 (in) | 3.0 | 4.5 | 6.3 |
| Sample 2 (in) | 3.5 | 4.5 | 6.5 |
| Sample 3 (in) | 3.5 | 4.5 | 6.0 |
| Average (in) | 3.3 | 4.5 | 6.3 |

TABLE 5
Frozen

| | Carpet 1 | Carpet 2 | Carpet 3 |
|---|---|---|---|
| Sample 1 (in) | 3.3 | 4.8 | 9.5 |
| Sample 2 (in) | 3.8 | 5.0 | 9.3 |
| Sample 3 (in) | 3.8 | 4.8 | 8.3 |
| Average (in) | 3.6 | 4.8 | 9.0 |

As can be seen in Tables 4 and 5, the recyclable tufted fabrics described herein provide superior flexibility over conventional carpets. In addition, the decrease in flexibility for recyclable tufted fabrics as described herein when frozen is much less than the decrease in flexibility for conventional carpets when frozen. As such, the recyclable tufted fabrics are much easier to install than conventional carpets, especially in cold climates.

Modifications of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1-33. (canceled)

34. A method of manufacturing a recyclable tufted fabric comprising:
providing a fabric backing;
tufting a plurality of yarns through the fabric backing such that a pile is provided at a first surface of the fabric backing and a plurality of yarn loops are provided at a second surface of the fabric backing; and
applying a liquid adhesive to the second surface of the fabric backing to anchor the plurality of yarn loops to the second surface of the fabric backing;
wherein the plurality of yarns are not fused to the fabric backing; and
wherein the liquid adhesive is a liquid hot melt adhesive, comprising a polymer consisting of at least one of a copolymer of polyethylene terephthalate (coPET), a copolymer of polypropylene (PP), or combinations thereof.

35. The method according to claim 34, wherein applying the liquid adhesive to the second surface of the fabric backing comprises applying the liquid adhesive via a hot melt roller coater, a hot melt slot die coater, a hot melt scatter coater, or a hot melt spray applicator.

36. The method according to claim 34, wherein the fabric backing is woven and comprises slit tape at 11-20 picks per inch in the weft direction and 20-31 ends per inch in the warp direction.

37. The method according to claim 34, wherein the fabric backing is nonwoven and comprises a plurality of PET filaments and a plurality of coPET filaments among a plurality of polyester filaments.

38. The method according to claim 37, wherein the plurality of PET and coPET filaments are distributed evenly within the plurality of polyester filaments.

39. The method according to claim 37, wherein the plurality of PET and coPET filaments are distributed randomly within the plurality of polyester filaments.

40. The method according to claim 34, wherein the recyclable tufted fabric is free of latex.

41. The method according to claim 34, wherein the liquid adhesive has a weight of 3 to 16 oz/yd².

42. A method of manufacturing a recyclable tufted fabric comprising:
providing a fabric comprising a backing and a plurality of tufts forming loops on first and second sides of the backing wherein long loops are configured on the first side of the backing and short loops are configured on the second side of the backing;
applying a liquid adhesive to the second side of the backing to anchor the short loops to the second side of the backing wherein the short loops are not fused to the backing; and
wherein the liquid adhesive is a liquid hot melt adhesive, comprising a polymer consisting of at least one of a copolymer of polyethylene terephthalate (coPET), a copolymer of polypropylene (PP), or combinations thereof.

43. The method according to claim 42, wherein applying the liquid adhesive to the second side of the backing comprises applying the liquid adhesive via a hot melt roller coater, a hot melt slot die coater, a hot melt scatter coater, or a hot melt spray applicator.

44. The method according to claim 42, wherein the backing and the plurality of yarns comprise polyethylene terephthalate (PET), polytrimethylene terephthalate (PTT), a polyamide polymer, polypropylene (PP) or a combination thereof.

45. The method according to claim 42, wherein the recyclable tufted fabric is free of latex.

46. The method according to claim 42, wherein the applied liquid adhesive has the same coefficient of expansion as the backing.

47. The method according to claim 42, wherein the recyclable tufted fabric comprises a tuft bind strength of greater than 6.25 lbs loop and greater than 3 lbs cut pile.

48. The method according to claim 42, wherein the recyclable tufted fabric comprises a tear strength of greater than 25 lbs in the cross direction or machine direction.

49. The method according to claim 42, wherein the recyclable tufted fabric comprises a tensile strength of greater than 100 lbs in the cross direction or machine direction.

50. The method according to claim 42, wherein the liquid adhesive has a melting temperature from about 130° C. to about 200° C.

51. The method according to claim 42, wherein the recyclable tufted fabric has at least a 25% greater flexibility between freezing and room temperatures when compared to a tufted fabric made with a latex adhesive.

52. A recyclable tufted fabric comprising;
a fabric backing;
a plurality of yarns tufted through the fabric backing such that a pile is provided at a first surface of the fabric backing and a plurality of yarn loops are provided at a second surface of the fabric backing;
a cooled polyester hot melt applied adhesive configured to anchor the plurality of yarn loops to the second surface of the fabric backing, the cooled polyester hot melt applied adhesive having a melting temperature from about 130° C. to about 200° C.; and
wherein the recyclable tufted fabric has at least a 25% greater flexibility between freezing and room temperatures when compared to a tufted fabric made with a latex adhesive.

53. The recyclable tufted fabric according to claim 52, wherein the plurality of yarns tufted through the fabric backing are not fused to the fabric backing and wherein the recyclable tufted fabric is free of latex.
